(19) United States
(12) Patent Application Publication
(10) Pub. No.: US 2007/0205975 A1
(43) Pub. Date: Sep. 6, 2007

(54) TEST SYSTEM FOR TESTING A LIQUID CRYSTAL DISPLAY MODULE AND METHOD THEREOF

(76) Inventor: Jung-Chung Lee, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/382,713

(22) Filed: May 11, 2006

(30) Foreign Application Priority Data
Feb. 17, 2006 (TW) 095105524

(51) Int. Cl. G09G 3/36

(52) U.S. Cl. 345/99

(57) ABSTRACT

A test system includes a parameter control platform including a control unit for generating a signal corresponding to control parameters of an LCD module, and a signal output interface coupled to the control unit for outputting the signal generated by the control unit. The test system further includes a system board including a signal input interface coupled to the signal output interface of the parameter control platform for receiving the signal generated by the control unit of the parameter control platform, a micro control unit coupled to the signal input interface for controlling the LCD module to display a corresponding frame according to the signal transmitted from the signal input interface, and a signal output interface coupled to the micro control unit for outputting a control signal generated by the micro control unit to the LCD module.

### BACKGROUND OF THE INVENTION

1. Field of the Invention

The present invention provides a test system and a method for testing a liquid crystal display module, in particular, provides a test system and a method using a parameter control platform for directly adjusting parameters of the liquid crystal display module.

2. Description of the Prior Art

With technologies advancing, intelligent information products that are light, energy-saving, and portable are everywhere in our lives. A display device plays an important role in the products. No matter if the product is a cellphone, Personal Digital Assistant (PDA), or a laptop computer, a display device is required to be a communicational interface between a human and a machine. Because a liquid crystal display has characteristics such as thin, light, low power consumption, and no radiations, it is widely spread and used in personal desktop computer monitors, laptop computers, PDAs, cellphones, and portable products as such. Liquid crystal displays are gradually replacing conventional Cathode Ray Tubes (CRTs) monitors for desktop computers. Since liquid crystal molecules have different polarization or refraction effects with different orientations, light penetration can be controlled through the orientation of the liquid crystal molecules. Therefore, different intensities of lights are output, which are characteristics used for generating different gray-level intensities of red, blue and green lights, and allow the liquid crystal displays to generate colorful images.

Due to different market requirements of the liquid crystal display module (LCD module), different LCD controller ICs are required to drive the LCD modules. However, there are many types of LCD modules and as commands, interfaces, and AC timing during driving are more or less different, only engineers who developed the LCD modules know control methods of the LCD controller ICs. Even though LCD module vendors can refer to specifications provided by LCD control IC vendors while using the LCD control ICs, engineers for the LCD module vendors still spend a lot of time researching driving the LCD modules. Besides, a same LCD control IC matches with different LCD modules in some cases and different LCD modules have different characteristics, so that parameters like duty, bias, contrast value etc. are required to be adjusted accordingly.

Please refer to FIG. 1. FIG. 1 is a functional block diagram of testing an LCD module 12 with a system board 10 in the prior art. The system board 10 comprises a Micro Control Unit (MCU) 14 for controlling the LCD module 12 to display images, and a signal output interface 16 coupled to the MCU 14 for outputting a control signal from the MCU 14 to the LCD module 12. The LCD module 12 comprises a signal input interface 18 coupled to the signal output interface 16 of the system board 10 through a Flexible Printed Circuit (FPC) 20 for receiving a control signal from the signal output interface 16 of the system board 10. The LCD module 12 further comprises an LCD panel 22, and an LCD control IC 24 coupled to the LCD panel 22 and the signal input interface 18 for driving the LCD panel 22 according to a control signal received from the signal input interface 18.

A method of testing the LCD module 12 with the system board 10 comprises writing a system driver into the MCU, which is coupled to the signal output interface 16 of the system board 10 with the FPC 20 and the signal input interface 18 of the LCD module 12, and driving the LCD panel 22 with the MCU 14 controlling the LCD control IC 24. However, if a test result shows that the LCD module 12 cannot be driven or parameters of the LCD panel 22 displaying corresponding images are erroneous, the system driver needs to be recompiled on another computer, then the recompiled system driver is written into the MCU 14 to repeat test procedures until test adjustments are completed. Hence, not only a great deal of time and money of the engineers of the LCD module vendors are consumed, but the method also causes inconvenience in using the LCD control ICs.

### SUMMARY OF THE INVENTION

A test system for testing a liquid crystal display module according to the present invention includes a parameter control platform having a control unit generating a signal of control parameters corresponding to the liquid crystal display module and a signal output interface coupled to the control unit for outputting the signal generated by the control unit. A system board including a signal input interface is coupled to the signal output interface of the parameter control platform for receiving the signal generated by the control unit of the parameter control platform. A micro control unit (MCU) is coupled to the signal input interface for controlling the liquid crystal display module to display images corresponding to a control signal transferred from the signal input interface. A signal output interface is coupled to the MCU for outputting the control signal generated by the MCU to the liquid crystal display module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of testing an LCD module with a system board in the prior art.

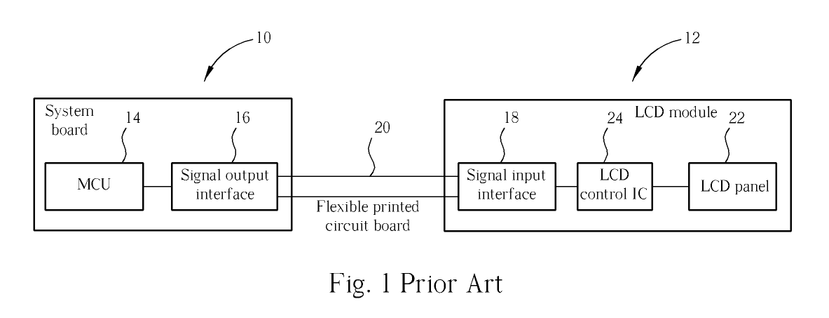

FIG. 2 is a functional block diagram of a test system for testing an LCD module according to the present invention

FIG. 3 is a flow chart of testing the LCD module in the present invention.

### DETAILED DESCRIPTION

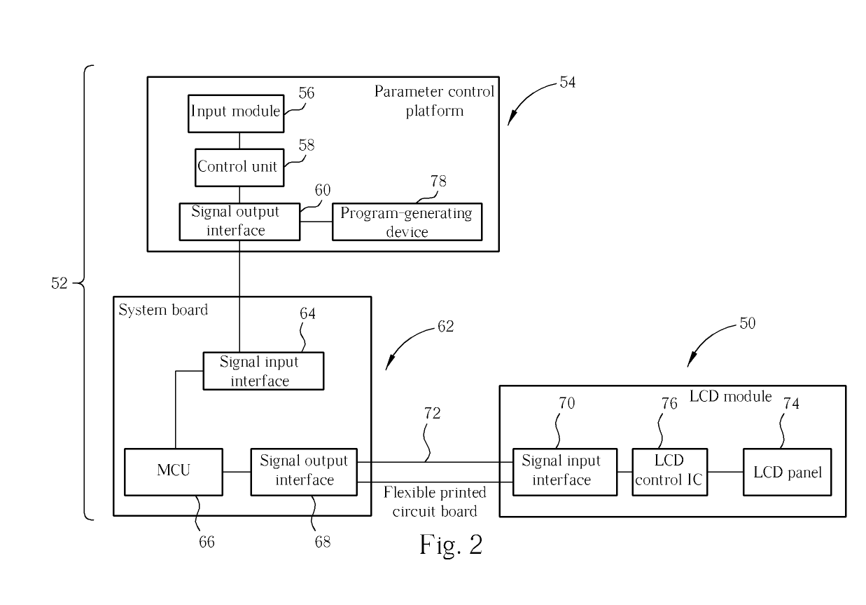

Please refer to FIG. 2. FIG. 2 is a functional block diagram of a test system 52 for testing an LCD module 50 according to the present invention. The test system 52 comprises a parameter control platform 54 which can be a computer. The parameter control platform 54 comprises an input module 56 for inputting control parameters to the LCD module 50, a control unit 58 for generating signals of the control parameters of the LCD module 50, and a signal output interface 60 coupled to the control unit 58 for outputting signals from the control unit 58. Furthermore, the parameter control platform 54 further comprises a program-generating device 78 for generating a system driver corresponding to an MCU 66 of a system board 62.

The test system 52 further comprises the system board 62, where the system board 62 comprises a signal input interface 64 coupled to the signal output interface 60 for receiving signals from the control unit 58 of the parameter control platform 54. The signal output interface 60 of the parameter control platform 54 and the signal input interface 64 of the system board 62 can be serial interfaces, parallel interfaces such wired data transmission interfaces, or wireless data transmission interfaces. The system board 62 further comprises the MCU 66 coupled to the signal input interface 64 for controlling the LCD module 50 to display images corresponding to signals from the signal output interface 64, and a signal output interface 68 coupled to the MCU 66 for outputting control signals from the MCU 66 to the LCD module 50.

The LCD module 50 comprises a signal input interface 70 coupled to a signal output interface 68 of the system board 62 with an FPC 72 for receiving the control signals sent from the signal input interface 68 of the system board 62. The LCD module 50 further comprises an LCD panel 74 and an LCD control IC 76 is coupled to the LCD panel 74 and the signal input interface 70 for driving the LCD panel 74 according to the control signals sent from the signal input interface 70.

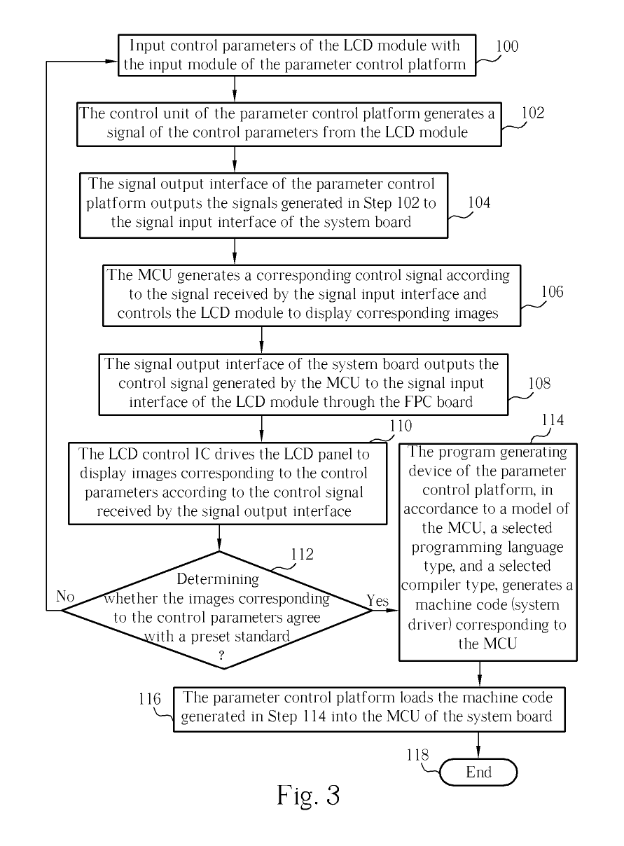

Please refer to FIG. 3. FIG. 3 is a flow chart of testing the LCD module 50 using the present invention. A method of the present invention comprises following steps.

Step 100: input control parameters of the LCD module 50 with the input module 56 of the parameter control platform 54.

Step 102: the control unit 58 of the parameter control platform 54 generates a signal of the control parameters from the LCD module 50.

Step 104: the signal output interface 60 of the parameter control platform 54 outputs the signals generated in Step 102 to the signal input interface 64 of the system board 62.

Step 106: the MCU 66 generates a corresponding control signal according to the signal received by the signal input interface 64 and controls the LCD module to display corresponding images.

Step 108: the signal output interface 68 of the system board 62 outputs the control signal generated by the MCU 66 to the signal input interface 70 of the LCD module 50 through the FPC board 72.

Step 110: the LCD control IC 76 drives the LCD panel 74 to display images corresponding to the control parameters according to the control signal received by the signal output interface 70.

Step 112: determining whether the images corresponding to the control parameters agree with a preset standard; if so, go to Step 114; if not, go to Step 100.

Step 114: the program generating device 78 of the parameter control platform 54, in accordance to a model of the MCU 66, a selected programming language type, and a selected compiler type, generates a machine code (system driver) corresponding to the MCU 66.

Step 116: the parameter control platform 54 loads the machine code generated in Step 114 into the MCU 66 of the system board 62.

Step 118: end.

Details of steps described above are stated as follows. First, the parameter control platform 54 is coupled to the system board 62 and the system board 62 is coupled to the LCD module 50. With the input module 56 of the parameter control platform 54, control parameters of the LCD module are input. The control parameters can be duty, bias, contrast value etc., and the input module 56 can be an application input interface. Then, the control unit 58 of the parameter control platform 54 generates the signal corresponding to the control parameters of the LCD module input from the input module 56 and outputs the signal generated to the signal input interface 64 of the system board through the signal output interface 60. A data transmission method between the signal output interface 60 of the parameter control platform 54 and the signal output interface 64 of the system board 62 can be a serial interface transmission method, a parallel interface transmission method, a wired data transmission method as such, or another wired or wireless data transmission method.

The MCU 66 of the system board 62 generates the control signal corresponding to the signal received by the signal input interface 64, and then the signal output interface 68 of the system board 62 outputs the control signal to the signal input interface 70 of the LCD module 50 through the FPC board 72. The LCD control IC 76, according to the control signal received by the signal input interface 70, drives the LCD panel to display images with corresponding control parameters.

Thereafter, with naked eyes or instruments, whether the images with corresponding control parameters agree with a preset standard is determined. For example, it is determined whether a display quality of the LCD module 50 is at its best. If the images are determined to be under the preset standard, which means the LCD module has a display quality with the parameters under the present standard, step 100 is repeated to adjust the control parameters of the LCD module 50 input by the input module 56 of the parameter control platform 54. Step 100 is repeated until the images displayed by the LCD module 50 with the corresponding parameters agree with the preset standard. If the images are determined to be agreeing the preset standard, which means the LCD module has a display quality with the parameters meeting the present standard and the current setting of the control parameters is able to drive the LCD module 50, the control parameters can be loaded into the MCU 66 of the system board 62 to drive the LCD module 50 according to the settings of the control parameters.

A method with the steps described above allows an application of the parameter control platform 54 to select a model of the MCU 66 of the system board, a type of program language to use, and a type of compiler to use. Hence, the program generating device 78 of the parameter control platform 54 generates a machine code (system driver) corresponding to the MCU 66. The program-generating device 78 can be a program generator for compiling program codes. The machine code generated is loaded into the MCU 66 of the system board 62 by the program-generating device 78, so the LCD module 50 is driven directly without further adjustments of the control parameters. Therefore the system board 62 with the machine code can be a system board for mass production that matches with the LCD module 50.

In comparison with the prior art, the test system and method of testing an LCD module according to the present invention uses a parameter control platform to directly adjust control parameters of the LCD module, hence directly adjust a display status of the LCD module. Therefore, with an instant view of the display status of the LCD module, the control parameters are dynamically adjusted with the parameter control platform. As a best setting of the control parameters is found, a corresponding system driver for driving the LCD module is generated and loaded into an MCU of a system board for mass production. Therefore, the present invention provides advantages of not having to repeatedly recompile a system driver on another computer before loading the driver into the MCU to repeat testing procedures until test adjustments are finished. The present invention also significantly reduces developing time and money of the engineers of the LCD module vendors, and makes the LCD control IC easier to use.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A test system for testing a liquid crystal display module comprising:
a parameter control platform comprising:
a control unit generating a signal of control parameters corresponding to the liquid crystal display module; and
a signal output interface coupled to the control unit for outputting the signal generated by the control unit; and
a system board comprising:
a signal input interface coupled to the signal output interface of the parameter control platform for receiving the signal generated by the control unit of the parameter control platform;
a micro control unit (MCU) coupled to the signal input interface for controlling the liquid crystal display module to display images corresponding to a control signal transferred from the signal input interface; and
a signal output interface coupled to the MCU for outputting the control signal generated by the MCU to the liquid crystal display module.

2. The test system of claim 1 wherein the parameter control platform further comprises an input module for inputting control parameters of the liquid crystal display module.

3. The test system of claim 1 wherein the parameter control platform further comprises a program generating device for generating corresponding system drivers of the MCU.

4. The test system of claim 1 wherein the signal output interface of the parameter control platform and the signal input interface of the system board are serial interfaces.

5. The test system of claim 1 wherein the signal output interface of the parameter control platform and the signal input interface of the system board are parallel interfaces.

6. The test system of claim 1 wherein the signal output interface of the parameter control platform and the signal input interface of the system board are wireless transmission interfaces.

7. The test system of claim 1 wherein the parameter control platform is a computer.

8. A method of testing a liquid crystal display module comprising:
a parameter control platform generating a signal corresponding to control parameters of the liquid crystal display module;
the parameter control platform outputting the signal corresponding to the control parameters of the liquid crystal display module to a MCU of a system board of the liquid crystal display module;
the MCU controlling the liquid crystal display module to display corresponding images according to the signal corresponding to the control parameters of the liquid crystal display module; and
adjusting the control parameter signal of the liquid crystal display module corresponding to the parameter control platform module according to the corresponding images displayed by the liquid crystal display module.

9. The method of claim 8 further comprising inputting the control parameters of the liquid crystal display module to the parameter control platform.

10. The method of claim 8 further comprising determining whether the corresponding images displayed by the liquid crystal display module agree with a preset standard.

11. The method of claim 10 wherein determining whether the corresponding images displayed by the liquid crystal display module agree with a preset standard is determining whether the corresponding images displayed by the liquid crystal display module agree with a preset standard with naked eyes.

12. The method of claim 10 wherein determining whether the corresponding images displayed by the liquid crystal display module agree with a preset standard is determining whether the corresponding images displayed by the liquid crystal display module agree with a preset standard with instruments.

13. The method of claim 8 further comprising:
the parameter control platform generating a corresponding machine code of the MCU according to a result yielded from determining whether the corresponding images displayed by the liquid crystal display module agree with the preset standard.

14. The method of claim 13 further comprising:
the parameter control platform generating the corresponding machine code of the MCU according to a model number of the MCU.

15. The method of claim 13 further comprising:
the parameter control platform generating the corresponding machine code of the MCU according to a selected programming language type.

16. The method of claim 13 further comprising:
the parameter control platform generating the corresponding machine code of the MCU according to a selected compiler type.

17. The method of claim 8 further comprising:
loading the machine code to the MCU of the system board.
